(19) United States
(12) Patent Application Publication
(10) Pub. No.: US 2005/0140475 A1
(43) Pub. Date: Jun. 30, 2005

(54) Interlocking apparatus of a leading under voltage trip mechanism for manual motor starter

(75) Inventor: Seung Heon Cho, Cheongju-si (KR)

Correspondence Address: GREENBLUM & BERNSTEIN, P.L.C., 1950 ROLAND CLARKE PLACE, RESTON, VA, 20191, US

(73) Assignee: LG Industrial Systems Co., Ltd., Seoul (KR)

(21) Appl. No.: 11/016,911

(22) Filed: Dec. 21, 2004

(30) Foreign Application Priority Data
Dec. 26, 2003 (KR) 10-2003-0097672

(51) Int. Cl. H01H 75/00; H01H 77/00

(52) U.S. Cl. 335/14; 335/202

(57) ABSTRACT

Disclosed is an interlocking apparatus of a leading undervoltage trip device for a manual motor starter. The interlocking apparatus comprises a rotatable handle for allowing a user to manually manipulate the manual motor starter to ON or OFF position; a handle power transmitting member concentrically connected to the handle to be integrally rotated with the handle and having a gear portion; and a lever portion extending in a direction perpendicular to an axis of the handle power transmitting member, to be interlocked with the leading undervoltage trip device.

### TECHNICAL FIELD

The present invention relates to an interlocking apparatus of a leading undervoltage trip device for a manual motor starter, and more particularly, to an interlocking apparatus of a leading undervoltage trip device for a manual motor starter, which can extend a lifetime of the undervoltage trip device and improve user convenience.

### BACKGROUND ART

In general, inside a circuit breaker, there are provided a detection section for detecting a fault current, a switching section operated by a detection signal from the detection section, a contact section interlocked with the operation of the switching mechanism section to open or close a current path, and an arc extinguishing section for extinguishing an arc generated when contacts of the contact section are opened. Outside the power-circuit breaker, a rotary type handle is provided to turn on the circuit breaker.

Also, accessory devices for transmitting a signal indicative of an operational state of the circuit breaker to the outside and thereby informing a user of the operational state of the circuit breaker, transmitting a signal inputted from the outside to the circuit breaker, etc. are coupled to a frame of the circuit breaker.

For example, the accessory devices include an undervoltage trip device for transmitting to the outside a signal indicating that a voltage lower than a rated voltage is applied to the circuit breaker, a remote control trip device for tripping the circuit breaker through remote control, and an alarm device or an indicating device for visually or audibly informing a user of the operational states (such as an ON state, an OFF state and a TRIP state) of the circuit breaker. Depending upon an application of a circuit breaker, one or more of various accessory devices is optionally on the frame of the circuit breaker.

Further, as means for transmitting the operational state of the circuit breaker to the outside, various methods are disclosed in the art, such as a method using the movement of a crossbar arranged in the circuit breaker, a method using the movement of a shift lever arranged in the circuit breaker, a method using the rotational displacement of the handle, and so forth.

FIG. 1 is a perspective view illustrating an example of a circuit breaker according to the conventional art. A rotary type handle 2 is installed on the body 1 of the motor protection circuit breaker which is also called a manual motor starter. An undervoltage trip device 10 serving as an accessory device is coupled to a side of the body 1 of the manual motor starter.

In the manual motor starter, if a user rotates the handle 2 to an ON position to turn on the circuit breaker, links of a switching section provided in the body 1 of the manual motor starter are moved while being interlocked with the rotation of the handle 2, to bring movable contacts and fixed contacts of a contact section into contact with each other, thereby allowing current flow. On the contrary, if the user rotates the handle 2 to an OFF position, as the links are moved, the movable contacts and fixed contacts are separated from each other to interrupt current flow. In the manual motor starter, a device for transmitting the rotational displacement of the handle 2 to the accessory device must be provided.

Among various accessory devices of the manual motor starter which are used for protecting a motor from being short-circuited or being overloaded, the undervoltage trip device 10 functions to trip the body 1 of the manual motor starter upon application of an undervoltage below the rated voltage.

FIGS. 2a and 2b are perspective views taken at different angles, illustrating an interlocking mechanism between a conventional undervoltage trip device 10 and the body 1 of the manual motor starter.

In FIGS. 2a and 2b, the reference numeral 2 designates a handle, 3 a handle wing lever, 4 a rotation plate, 10 an undervoltage trip device, and 19 a crossbar projection of the undervoltage trip device 10.

FIG. 3 is a view illustrating an operating structure which is interlocked with a handle 2 of the body 1 of the manual motor starter for operating the conventional undervoltage trip device 10.

As shown in FIG. 3, in an interlocked structure of the conventional undervoltage trip device 10, a wing lever 3 being a separate interlocked lever of the undervoltage trip device is installed to be operated only in an interval between an OFF position and a TRIP position which corresponds to 0°˜45°. Inside the undervoltage trip device 10, there is arranged a separate mechanism capable of allowing and interrupting internal power application to the undervoltage trip device 10 by way of the handle wing lever 3 of the body 1 of the manual motor starter.

FIG. 4 is a structural view illustrating an inner structure of the conventional undervoltage trip device 10. The inner structure includes a movable core 12, an undervoltage trip device coil 13, a movable core cap 14, a crossbar rotation shaft 15, fixed contacts 16, a crossbar 17, movable contacts 18, and a crossbar projection 19.

The interlocked structure of the conventional undervoltage trip device 10 is constructed in a manner such that, only when the user manipulates the handle 2 to use the body 1 of them anual motor starter, the undervoltage trip device 10 can operate in a leading manner. Detailed operation of the undervoltage trip device 10 and the body 1 of the manual motor starter is disclosed in U.S. Pat. No. 6,326,871 issued on Aug. 6, 1998.

The leading undervoltage trip device 10 according to the conventional art, constructed as mentioned above, suffers from defects in that, since it is more expensive than a general undervoltage trip device, it cannot help but have a limited user group. Also, in order to interlock the undervoltage trip device 10, since the interlocked lever structure operating only in the interval between the OFF position and the TRIP position which corresponds to 0°˜45° must be provided to the body 1 of the manual motor starter, a cost for manufacturing the body 1 of the manual motor starter increases.

### DISCLOSURE OF THE INVENTION

Therefore, the present invention has been made in view of the above-mentioned problems, and an object of the present invention is to provide an interlocking apparatus of a leading undervoltage trip device for a manual motor starter, in which a lever section for interlocking the leading undervoltage trip device with a power transmitting member of a handle for operating a switching section of the body of the manual motor starter is integrated with the power transmitting member, so that parts are not added to the body of the manual motor starter and only a user using the leading undervoltage trip device bears expenses for the corresponding function, thereby reducing a manufacturing cost and a purchase price of a manual motor starter.

In order to achieve the above object, according to the present invention, there is provided an interlocking apparatus of a leading undervoltage trip device for a manual motor starter, comprising: a rotatable handle for allowing a user to manually manipulate the manual motor starter to ON or OFF position;
a handle power transmitting member concentrically connected to the handle to be integrally rotated with the handle and having a gear portion; and
a lever portion extending in a direction perpendicular to an axis of the handle power transmitting member, to be interlocked with the leading undervoltage trip device.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a perspective view illustrating an example of a manual motor starter according to the conventional art;

FIGS. 2a and 2b are perspective views taken at different angles, illustrating an interlocking mechanism between a conventional undervoltage trip device and the body of the manual motor starter;

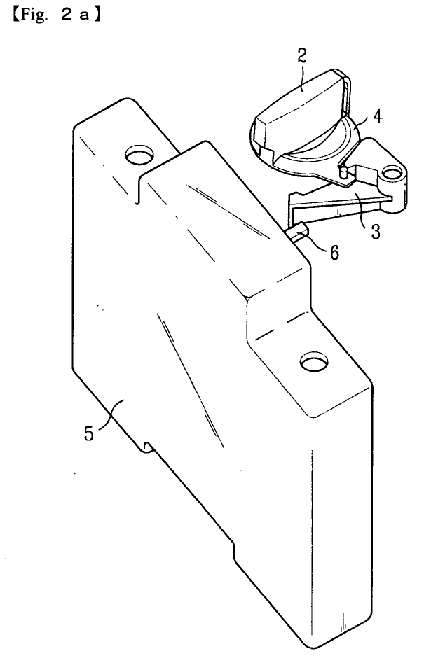

FIG. 3 is a view illustrating an operating structure which is interlocked with a handle of the body of the manual motor starter for operating the conventional undervoltage trip device;

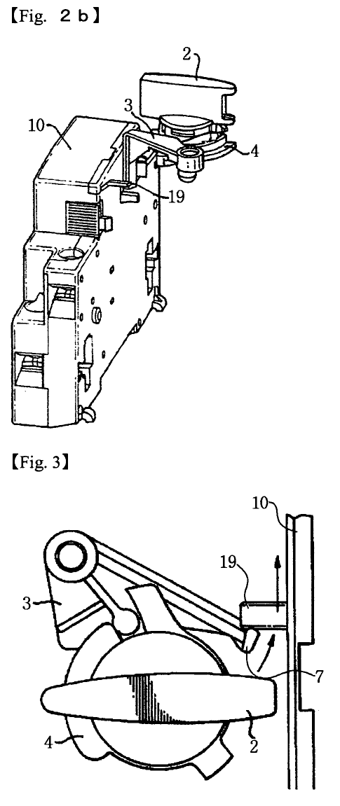

FIG. 4 is a structural view illustrating an inner structure of the conventional undervoltage trip device; and

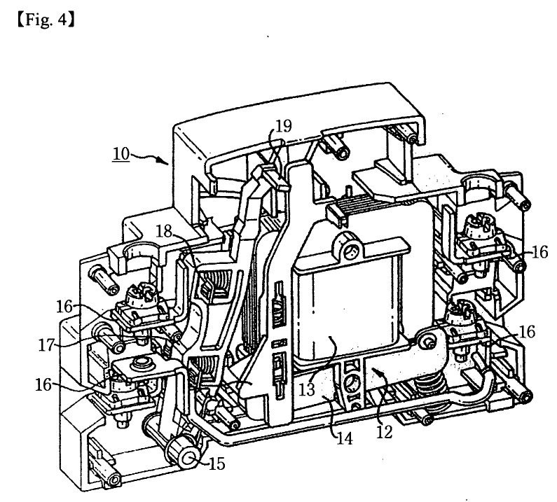

FIGS. 5a and 5b are perspective views taken at opposing angles, illustrating an interlocking mechanism between an undervoltage trip device and the body of a manual motor starter, in accordance with an embodiment of the present invention.

### BEST MODE FOR CARRYING OUT THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

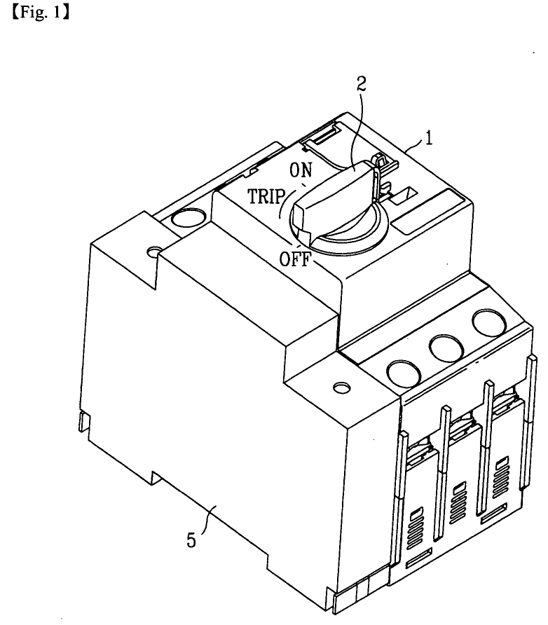

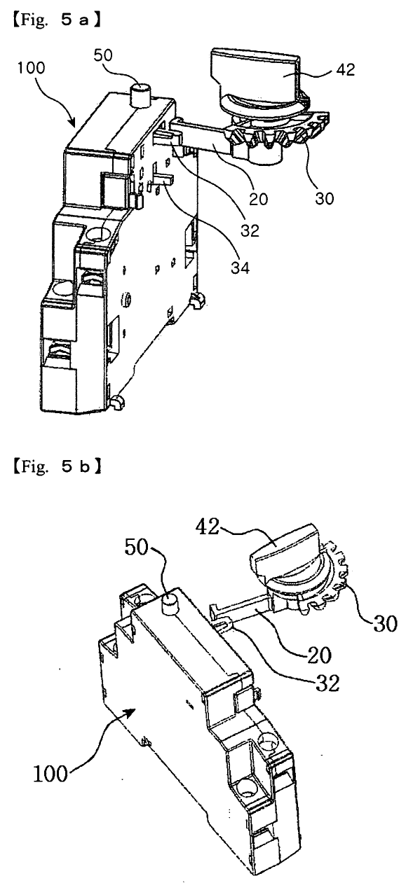

FIGS. 5a and 5b are perspective views taken at opposing angles, illustrating an interlocking mechanism between an undervoltage trip device 100 and the body 1 (see FIG. 1) of a manual motor starter, in accordance with an embodiment of the present invention.

An interlocking apparatus of a leading undervoltage trip device 100 for a manual motor starter, in accordance with an embodiment of the present invention, comprises a rotatable handle 42 for allowing a user to manually manipulate the manual motor starter to ON or OFF positions; a handle power transmitting member 30 concentrically connected to the handle 42 to be integrally rotated with the handle 42 and having a gear portion; and a lever portion 20 extending in a direction perpendicular to an axis of the handle power transmitting member 30, to be interlocked with the leading undervoltage trip device 100.

In FIGS. 5a and 5b, the body 1 of the manual motor starter is omitted. The undervoltage trip device 100 is coupled to a side of the body 1 of the manual motor starter and has a lever projection 32 for receiving power from the lever section 20. If an undervoltage is applied to the undervoltage trip device 100, a switching mechanism section of the body 1 of the manual motor starter is tripped by power transmitted through an interlocked lever 34.

As shown in FIGS. 5a and 5b, an operating switch 50 for applying electric power to the undervoltage trip device 100 is provided to the upper end of the undervoltage trip device 100.

Hereafter, operation of the interlocking apparatus of the leading undervoltage trip device 100 for the manual motor starter according to the present invention will be described with reference to FIGS. 5a and 5b.

If a user fully rotates the handle 42 to an OFF position, the handle power transmitting member 30 is rotated, and the lever portion 20 formed integrated with the handle power transmitting member 30 is rotated integrally with the handle power transmitting member 30. By this fact, the lever projection 32 of the undervoltage trip device 100 is pushed and moved. Then, by an inner mechanism of the undervoltage trip device 100 which is not shown in the drawings, including component elements such as the coil described in the explanation of the conventional art, contacts for allowing or interrupting current flow through the coil, an operating lever extending integrally from the lever projection 32 to move the contacts, and so forth, power application to the coil is interrupted, whereby it is possible to prevent the undervoltage trip device 100 from burning and extend a lifetime of the undervoltage trip device 100.

In the case that trip is effected while using the manual motor starter, the undervoltage trip device 100 is operated as it is without being changed in its operation state.

If the user rotates the handle 42 to an ON position, the lever section 20 is rotated by 90° from the OFF position where it comes into contact with the lever projection 32 of the undervoltage trip device 100, to be separated from the lever projection 32 of the undervoltage trip device 100. In this state, the undervoltage trip device 100 operates independently of the body 1 of the manual motor starter. That is to say, if the user presses the operation switch 50 for applying electric power to the undervoltage trip device 100, the undervoltage trip device 100 is maintained in a turned-on state, and if the user presses again the operation switch 50, the undervoltage trip device 100 is turned off.

Meanwhile, if an undervoltage is applied to the undervoltage trip device 100, for example, as described in the explanation of the conventional art, when a voltage less than a predetermined voltage is applied to the lower part of the coil, the switching mechanism section of the body 1 of the manual motor starter which is interlocked with the projection of the interlocked lever 34 is displaced to a trip position, through the movement of a lever rotated by elastic force of a spring and the movement of the interlocked lever 34 which is raised and lowered while being interlocked with the lever.

As described above, the interlocking apparatus of the leading undervoltage trip device for the manual motor starter according to the present invention is constructed in a manner such that, when the body 1 of the manual motor starter is not used, the interlocking apparatus is interlocked with the handle 42 of the body 1 of the manual motor starter to automatically interrupt electric power application to the undervoltage trip device 100.

Accordingly, the interlocking apparatus of the leading undervoltage trip device for the manual motor starter according to the present invention extends a lifetime of the undervoltage trip device, and removes convenience caused when the user installs and manages a separate undervoltage trip device operating switch, thereby improving user convenience.

### Industrial Applicability

As apparent from the above description, the interlocking apparatus of a leading undervoltage trip device for a manual motor starter, according to the present invention, provides advantages in that, since a lever portion for interlocking the leading undervoltage trip device with a power transmitting member of a handle for operating a switching mechanism section of the body of the manual motor starter is integrated with the power transmitting member, separate parts are not added to the body of the manual motor starter, and, since only the undervoltage trip device can perform an undervoltage trip function, only a user using the undervoltage trip device bears expenses for the corresponding function, whereby it is possible to reduce a manufacturing cost and a purchase price of a manual motor starter.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. An interlocking apparatus of a leading undervoltage trip device for a manual motor starter, comprising:
a rotatable handle for allowing a user to manually manipulate the manual motor starter to ON or OFF position;
a handle power transmitting member concentrically connected to the handle to be integrally rotated with the handle and having a gear portion; and
a lever portion extending in a direction perpendicular to an axis of the handle power transmitting member, to be interlocked with the leading undervoltage trip device.
